(19) United States
(12) Patent Application Publication
(10) Pub. No.: US 2024/0370325 A1
(43) Pub. Date: Nov. 7, 2024

(54) DATA PROCESSING SYSTEM, METHOD FOR MANAGING PROCESSING ORDER OF DATA, AND PROGRAM

(71) Applicant: TOYOTA JIDOSHA KABUSHIKI KAISHA, Aichi-ken (JP)

(72) Inventors: Mustafa ERDOGAN, Tokyo-to (JP); Hitoshi KAMADA, Tokyo-to (JP); Naphatthara PHLOYNGAM, Tokyo-to (JP); Rajat SAINI, Tokyo-to (JP); Norimasa KOBORI, Tokyo-to (JP)

(21) Appl. No.: 18/592,520

(22) Filed: Mar. 1, 2024

(30) Foreign Application Priority Data
May 1, 2023 (JP) 2023-075615

(51) Int. Cl. G06F 9/54

(52) U.S. Cl. CPC G06F 9/546

(57) ABSTRACT

The data processing system includes an order manager. The order manager passes to the sequential microservice data corresponding to a minimum timestamp message having the smallest timestamp in a message queue containing a predetermined number of messages consumed from the plurality of microservices. The order manager then continues to consume new messages from the plurality of microservices one by one until a message with a timestamp greater than the minimum timestamp message is obtained, and adds the message with the greater timestamp to the message queue when the message with the greater timestamp is obtained.

### CROSS-REFERENCE TO RELATED APPLICATION

The present application claims priority under 35 U.S.C. § 119 to Japanese Patent Application No. 2023-075615, filed May 1, 2023, the contents of which application are incorporated herein by reference in their entirety.

### BACKGROUND

### Field

The present disclosure relates to a data processing system, a method for managing a processing order of data, and a program.

### Background Art

Japanese Patent No. 7031424 discloses a prior art relating to a system for performing distributed processing of data in a microservice. In this prior art, messages are communicated between a plurality of microservices, the messages received by each microservice are stored in a queue in the order of arrival, and predetermined message processing is performed in the order of storage. Also, in this prior art, a message arriving with a delay is detected by comparing time stamps among a plurality of received messages. When there is a message that arrives with a delay, the message is rolled back to the message processing state before the message that arrives with a delay, and message processing is performed again in the correct order of arrival.

In the prior art described above, even if there is a delay in message arrival, each of the plurality of microservices can process messages in the correct order of arrival. However, in the prior art, a system in which a plurality of microservices are connected in parallel to a sequential microservice that sequentially processes data arranged in time series has not been sufficiently studied.

In addition to Japanese Patent No. 7031424, Japanese Patent No. 7126712 can be exemplified as a document showing the technical level of the technical field related to the present disclosure.

### SUMMARY

The present disclosure has been made in view of the above problem. It is an object of the present disclosure to maintain time-series order of data input to a sequential microservice in a system in which a plurality of microservices is connected in parallel to the sequential microservice.

To achieve the above object, the present disclosure provides a data processing system. A data processing system according to the present disclosure includes a sequential microservice that sequentially processes data arranged in time series, a plurality of microservices connected in parallel to the sequential microservice, and an order manager. The order manager has a function of managing the processing order in the sequential microservice of data processed in parallel by a plurality of microservices. Specifically, the order manager is configured to repeatedly execute the following first processing, second processing and third processing. The first processing is to pass data corresponding to a minimum time stamp message having the minimum time stamp in a message queue containing a predetermined number of messages consumed from a plurality of microservices to the sequential microservice. The second process is to continue consuming new messages from the plurality of microservices one by one until a message having a timestamp greater than the minimum timestamp message is obtained. The third processing is to add the message having the greater timestamp to the message queue when the message having the greater timestamp is obtained.

The data processing system of the present disclosure may further comprise a message broker and a database. The message broker functions to mediate metadata of messages between the plurality of microservices and the sequence manager, and the database stores a payload corresponding to each message. The order manager may be configured to retrieve from the database a payload corresponding to the metadata consumed from the message broker.

The present disclosure provides a method for achieving the above object. The method of the present disclosure is a method for managing a processing order in a sequential microservice of data processed in parallel in a plurality of microservices, and includes the following three steps that are repeatedly performed. In the first step, data corresponding to a minimum time stamp message having the minimum time stamp in a message queue containing a predetermined number of messages consumed from a plurality of microservices is passed to the sequential microservice. The second step is to continue consuming new messages from the plurality of microservices one by one until a message with a timestamp greater than the minimum timestamp message is obtained. The third step is to add the message with the greater timestamp to the message queue when the message with the greater timestamp is obtained.

The present disclosure provides a program for achieving the above object. A program according to an embodiment of the present disclosure is a program including a plurality of instructions executed by at least one processor. The plurality of instructions is configured to cause the at least one processor to function as a sequential microservice that sequentially processes data arranged in time series, a plurality of microservices connected in parallel to the sequential microservice, and an order manager that manages a processing order of the data processed in parallel by the plurality of microservices in the sequential microservice. The plurality of instructions is configured to cause the order manager to repeatedly perform the above-described first processing, second processing, and third processing. The program according to the present disclosure may be recorded in a computer-readable recording medium.

The present disclosure also provides another data processing system having a configuration different from that of the data processing system described above. The other data processing system comprises one or more message producers, one or more message consumers, a message broker, and a database. The message broker is capable of mediating metadata of messages between one or more message producers and one or more message consumers, and the database stores a payload corresponding to each message. Each of the one or more message consumers is configured to retrieve from the database a payload corresponding to the metadata consumed from the message broker.

According to the technique of the present disclosure, when a message newly consumed from a plurality of microservices in a parallel relationship is an older message than a processed message, the older message is discarded without being passed to the sequential microservice. Then, data corresponding to a minimum time stamp message having the minimum time stamp among the predetermined number of messages is passed to the sequential microservice. As a result, the time-series order of the data input to the sequential microservice can be maintained while the data is processed in parallel by the plurality of microservices, so that the data processing speed in the system is improved.

### BRIEF DESCRIPTION OF THE DRAWINGS

FIG. 1 is a diagram illustrating an example of a configuration of a data processing system according to a first embodiment;

FIG. 2 is a diagram for explaining processing performed by an order manager;

FIG. 3 is a diagram illustrating an example of a configuration of a data processing system according to a second embodiment;

FIG. 4 is a diagram illustrating an example of a configuration of a data processing system according to a third embodiment;

FIG. 5 is a diagram illustrating an example of a configuration of a data processing system according to a third embodiment; and

FIG. 6 is a view showing a comparative example to the third embodiment.

### DETAILED DESCRIPTION

### 1. First Embodiment

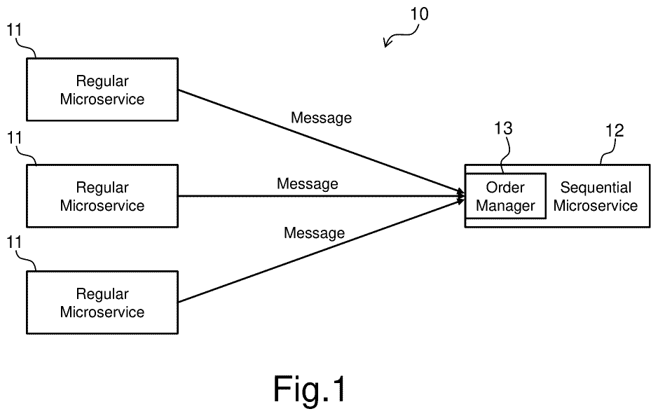

A data processing system according to an embodiment of the present disclosure is a system processing of data in a microservice. FIG. 1 illustrates an example of a configuration of a data processing system 10 according to the first embodiment. The data processing system 10 comprises a plurality of regular microservices 11 and at least one sequential microservice 12. In the example shown in FIG. 1, one sequential microservice 12 is provided for three regular microservices 11.

The regular microservice 11 is a microservice which is not the sequential microservice 12. While the sequential microservice 12 is a microservice for sequentially processing data arranged in time series, the regular microservice 11 does not require the data to be input in time series order. The regular microservices 11 are different from each other in service content.

The regular microservice 11 is connected in parallel to the sequential microservice 12. This means that there is no dependency between the regular microservices 11, and each regular microservice 11 can process data in parallel. Each regular microservice 11 sends messages to the microservice 12 independently of each other. Also, communication between each regular microservice 11 and the sequential microservice 12 is asynchronous.

Since the respective regular microservices 11 process data in parallel and are asynchronous with the sequential microservice 12, the order of data arriving at the sequential microservice 12 is not always the order to be processed. To this end, the data processing system 10 further comprises an order manager 13. The order manager 13 has a function of managing the processing order in the sequential microservice 12 of the data processed in parallel by the regular microservice 11.

Order manager 13 may be configured as part of sequential microservice 12 as shown in FIG. 1 or may be configured as a separate component from sequential microservice 12. The order manager 13 is provided between the regular microservice 11 and the sequential microservice 12 and receives a message transmitted from the regular microservice 11 to the sequential microservice 12.

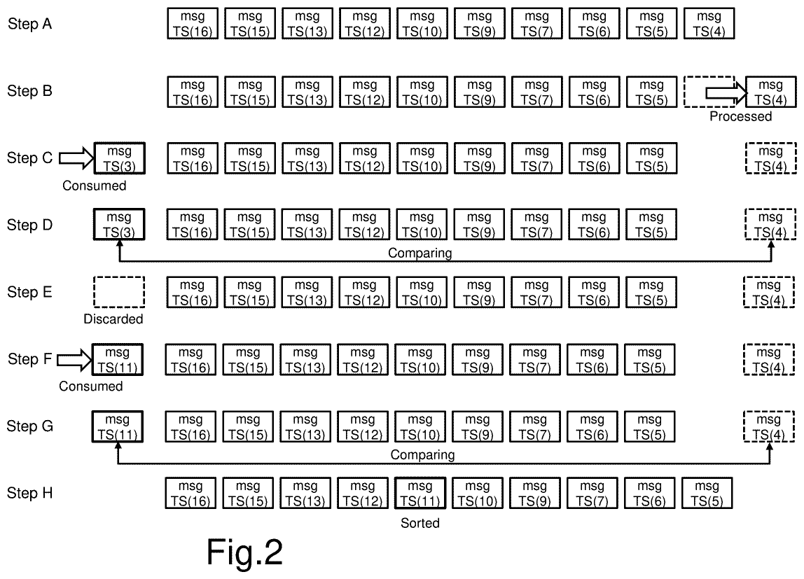

FIG. 2 shows a specific example of processing performed by the order manager 13. The order manager 13 is a message queue capable of storing a predetermined number of messages consumed from the regular microservice 11. In the example shown in FIG. 2, a total of ten messages are stored in the order manager 13. Note that the message is denoted by msg. TS (x) attached to each message in FIG. 2 represents a time stamp, and the smaller the value of x, the older the message. Hereinafter, processing performed by the order manager 13 will be described in the order of steps.

In step A, the order manager 13 sorts the messages stored in the message queue in order of time stamp. In the sequence of messages in step A, the smallest timestamp is TS (4), and the message with timestamp TS (4) is the smallest timestamp message.

Next, in step B, the order manager 13 processes the minimum timestamp message in the message queue and passes the data corresponding to the minimum timestamp message to the sequential microservice 12. The message with the time stamp TS (4) is thereby processed.

Next, in step C, the order manager 13 consumes one new message from the regular microservice 11. Which regular microservice 11 consumes the message depends on the transmission timing of the message of each regular microservice 11. In the example shown in FIG. 2, a message having the time stamp TS (3) is newly consumed.

Next, in step D, the order manager 13 compares the timestamp of the message newly consumed in step C with the timestamp of the minimum timestamp message processed in step B. Depending on the result of this comparison, the content of the processing performed by the order manager 13 in the next step varies.

In the case of step D, the timestamp TS (3) of the newly consumed message is less than the timestamp TS (4) of the previously processed minimum timestamp message. That is, the newly consumed message is older than the previously processed message. In this case, processing the data of the newly consumed message may cause inconvenience to the service because the data to be processed in time series is processed in reverse order.

Then, in step E, the order manager 13 discards the message newly consumed in step C, i.e. the message having the time stamp TS (3), without adding it to the message queue.

Then, in step F, the order manager 13 again consumes one new message from the regular microservice 11. In the example shown in FIG. 2, a message having a time stamp TS (11) is newly consumed.

Next, in step G, the order manager 13 compares the timestamp of the message newly consumed in step F with the timestamp of the previously processed minimum timestamp message. The previously processed minimum timestamp message is the message having the timestamp TS (4) processed in step B.

The order manager 13 continues to consume new messages one by one from the regular microservice 11 until a message is obtained having a timestamp greater than the minimum timestamp message. In the case of step G, the timestamp TS (11) of the newly consumed message is greater than the timestamp TS (4) of the previously processed minimum timestamp message. In other words, the newly consumed message is newer than the previously processed message. In this case, by processing data of a newly consumed message, data to be processed in time series can be processed in time series.

Then, in step H, the order manager 13 adds the message newly consumed in step C, i.e. the message with the time stamp TS (11), to the message queue. Then, the order manager 13 sorts the messages stored in the message queue in the order of the time stamps.

By performing the above-described processing by the order manager 13, the time-series order of the data input to the sequential microservice 12 can be maintained while the data is processed in parallel by the plurality of regular microservices 11. As a result, data processing system 10 can achieve a high data processing speed.

### 2. Second Embodiment

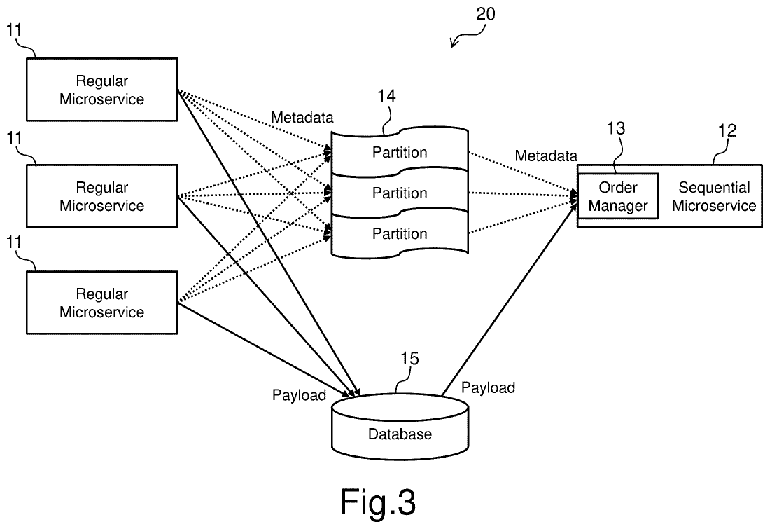

FIG. 3 shows an example of the configuration of a data processing system 20 according to the second embodiment. In FIG. 3, elements denoted by the same reference numerals as those of the data processing system 10 according to the first embodiment are elements having the same functions. Data processing system 20 is a system that uses message broker 14 to pass a plurality of messages. The data processing system 20 comprises a message broker 14 and a database 15 in addition to a plurality of regular microservices 11, sequential microservices 12 and an order manager 13.

A message output from each regular microservice 11 includes metadata and a payload. Message broker 14 mediates the metadata of messages between regular microservice 11 and sequential microservice 12. The message broker 14 comprises a plurality of partitions. The metadata transmitted from each regular microservice 11 is stored in the associated partition. On the other hand, the payload of the message is stored in the database 15. An example of the payload is image data.

In data processing system 20, order manager 13 consumes metadata from message broker 14 one at a time. The processing for the consumed metadata is similar to the processing for the message performed in the first embodiment. That is, the order manager 13 processes the metadata having the smallest timestamp among a predetermined number of metadata consumed from the message broker 14. Then, each time one piece of metadata in the message queue is processed, one piece of new metadata is consumed from the message broker 14, and the time stamp is compared with the time stamp of the previously processed metadata. If the time stamp of the newly consumed metadata is less than or equal to that of the previously processed metadata, the order manager 13 discards the newly consumed metadata and again consumes one new metadata from the message broker 14. On the other hand, if the time stamp of the newly consumed metadata is greater than that of the previously processed metadata, the order manager 13 processes the newly consumed metadata.

When processing the metadata, the order manager 13 retrieves the payload corresponding to the metadata from the database 15. Then, the extracted payload is transferred to the sequential microservice 12 together with the metadata. Thus, the data (payload) to be processed in time series can be processed in time series in the sequential microservice 12.

According to the data processing system 20 configured as described above, as in the first embodiment, the time-series order of the data input to the sequential microservice 12 can be held while the data is processed in parallel by the plurality of regular microservices 11. Further, since the data transferred via the message broker 14 is only the metadata, it is possible to reduce the waiting time required for the data transfer as compared with the case where the entire message is transferred, and it is possible to reduce the work time of the entire data processing system 20.

### 3. Third Embodiment

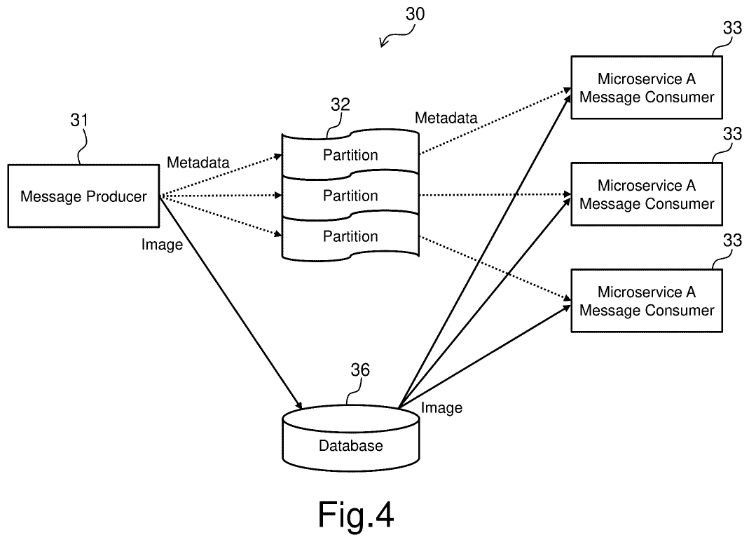

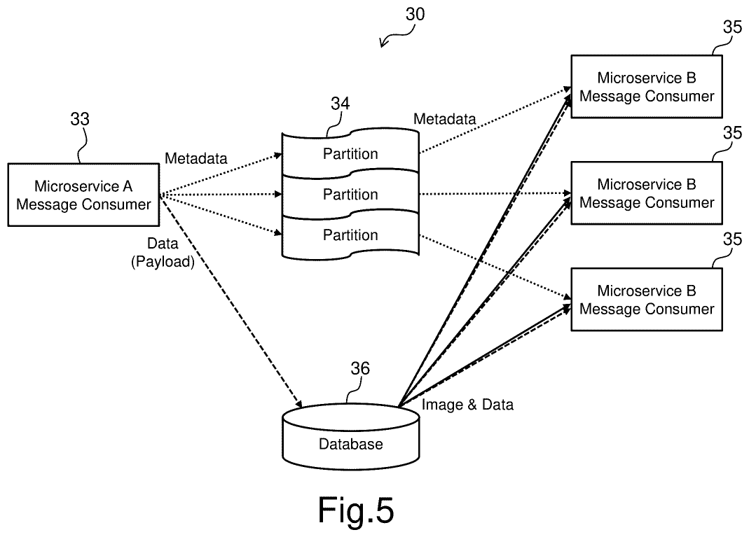

FIGS. 4 and 5 show an example of the configuration of a data processing system 30 according to the third embodiment. The data processing system 30 is the same as the data processing system 20 according to the second embodiment in that metadata is transferred via a message broker and a payload is transferred via a database. However, unlike data processing system 30, data processing system 20 does not have a sequential microservice as an essential component.

The data processing system 30 has a configuration in which a plurality of microservices are connected in a plurality of stages via message brokers. The data processing system 30 is a system for processing an image obtained from a camera by a microservice A and processing the image obtained from the camera and data obtained by processing the image by the microservice A by a microservice B. More specifically, data processing system 30 is a system that implements microservice B through an image processing pipeline that requires both an image and data output by microservice A.

FIG. 4 shows a configuration of a preceding stage of the data processing system 30. Located most upstream of data processing system 30 is message producer 31. In this embodiment, it is assumed that the message producer is a camera stream reader that distributes images acquired by a camera. The message generated by the message producer 31 includes metadata and an image as a payload.

The message generated by message producer 31 is processed by microservice A. Microservice A comprises a plurality of message consumers 33. The plurality of message consumers 33 process the message in a distributed manner to generate the data required by microservice B.

Metadata and images are separately transferred between the message producer 31 and each service consumer 33. The data processing system 30 comprises a message broker 32 for passing metadata between a message producer 31 and each message consumer 33. The message broker 32 comprises a plurality of partitions. The metadata transmitted from the message producer 31 is stored in the plurality of partitions according to a predetermined rule.

Data processing system 30 also includes a database 36 for passing images between message producer 31 and each message consumer 33. The message producer 31 transmits the metadata to the message broker 32 and simultaneously stores the corresponding image in the database 36.

The metadata stored in each partition of the message broker 32 is consumed one by one by the corresponding message consumer 33. Each time the message consumer 33 consumes metadata, the message consumer 33 searches the database 36 using the consumed metadata as a search key. Message consumer 33 then retrieves the retrieved image from database 36 and processes the retrieved image. The microservice A is executed by performing such processing in each message consumer 33.

FIG. 5 shows a configuration of a subsequent stage of the data processing system 30. More specifically, FIG. 5 shows a configuration of a subsequent stage of the data processing system 30 when attention is paid to one of the plurality of message consumers 33 included in the microservice A. The data resulting from the processing by message consumer 33 of microservice A is processed by microservice B. Microservice B comprises a plurality of message consumers 35. The microservice B performs distributed processing of data obtained by the message consumer 33 of the microservice A by the plurality of message consumers 35.

However, the data resulting from the processing by the message consumer 33 is divided into metadata and payload, i.e. net data. Then, metadata and net data are separately transferred between the message consumer 33 and each message consumer 35. The data processing system 30 comprises a message broker 34 for passing metadata between the message consumer 33 and each message consumer 35. The message broker 34 comprises a plurality of partitions. The metadata transmitted from the message consumer 33 is stored in the plurality of partitions according to a predetermined rule.

The message consumer 33 also transmits the metadata to the message broker 34 and stores the corresponding data (payload) in the database 36. In the database 36, each image input from the message producer 31 is associated with each data input from the message consumer 33. The database 36 may be a relational database or a NoSQL database, in particular a graph database.

The metadata stored in each partition of the message broker 34 is consumed one by one by the corresponding message consumer 35. Each time the message consumer 35 consumes metadata, the message consumer 35 searches the database 36 using the consumed metadata as a search key. The message consumer 35 then retrieves the retrieved image and data set from the database 36 and processes the retrieved image and data set. The microservice B is executed by performing such processing in each message consumer 35.

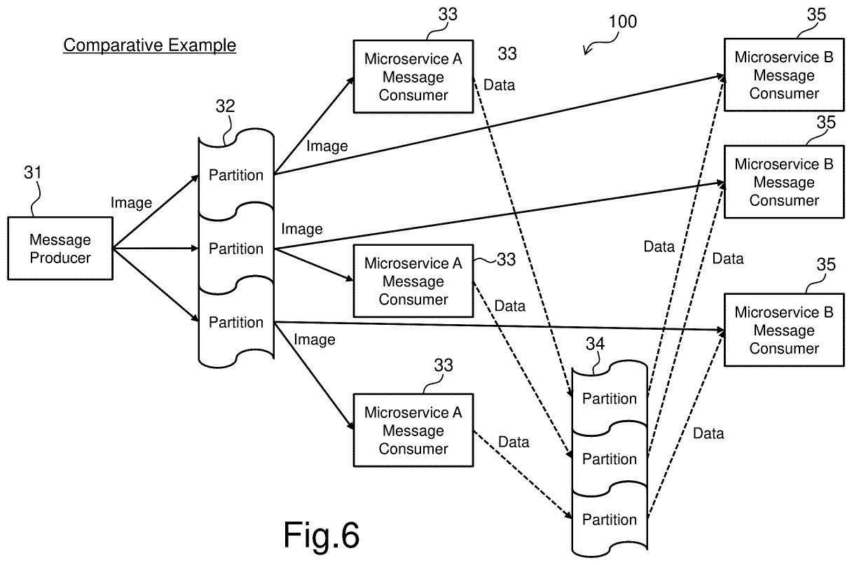

The effect of the data processing system 30 configured as described above can be explained by comparison with a comparative example. FIG. 6 is a diagram showing a configuration of a data processing system 100 as a comparative example to the data processing system 30. In FIG. 6, elements denoted by the same reference numerals as those of the data processing system 30 are elements having the same functions.

Like the data processing system 30, the data processing system 100 as the comparative example is a system that processes an image by the microservice A and further processes the image and data obtained by the processing of the image by the microservice A by the microservice B. However, while the data processing system 30 uses a message broker and a database to transfer data, the data processing system 100 transfers all data by a message broker.

In the data processing system 100, an image (including metadata) generated by the message producer 31 is transmitted to the message broker 32 and stored in a plurality of partitions included in the message broker 32 according to a predetermined rule. The images stored in each partition of the message broker 32 are consumed one by one by the corresponding message consumer 33 and processed by the message consumer 33. The microservice A is executed by processing the image in each message consumer 33.

Data (including metadata) obtained by the processing by each message consumer 33 of the microservice A is transmitted to the message broker 34 and stored in a plurality of partitions included in the message broker 34 according to a predetermined rule. The data stored in each partition of the message broker 34 is consumed one by one by the corresponding message consumer 35. In addition, message consumer 35 consumes images from message broker 32. The message consumer 35 performs matching between the consumed image and data and processes the matching image and data as a set. The microservice B is executed by performing such processing in each message consumer 35.

In the data processing system 100 of the comparative example configured as described above, image transfer by the message broker 32 is performed a plurality of times in the image processing pipeline. For this reason, a waiting time occurs due to an increase in traffic in the message broker 32, and the work time of the entire data processing system 100 increases. In this regard, in the third embodiment of the data processing system 30, latency in the message broker 32 is reduced because images are passed through the database 36.

In the data processing system 100 of the comparative example, the microservice B needs to perform matching between the data output from the microservice A and the image coming from the stream. This task is not always easy and requires a lot of memory. In particular, if a microservice requires as its input the output of several other microservices, matching becomes more difficult and the memory used for that microservice increases dramatically in a short time. In this regard, in the data processing system 30 according to the third embodiment, when the microservice B consumes the metadata, the set of the image and the data related to the metadata is acquired from the database 36, so that it is not necessary to perform complicated matching in the microservice B.

### 4. Hardware

The data processing system according to each of the above-described embodiments can be configured by, for example, a server. A server constituting a data processing system includes at least one processor and at least one memory storing a data processing program executed by the at least one processor. The data processing program includes a plurality of instructions and may be stored in a non-transitory computer-readable storage medium. A plurality of instructions of a data processing program are executed by at least one processor to perform pipeline processing in a data processing system.

What is claimed is:

1. A data processing system, comprising:
a sequential microservice configured to sequentially process data arranged in a time series;
a plurality of microservices connected in parallel to the sequential microservice; and
an order manager configured to manage an order in which the sequential manager processes data processed in parallel by the plurality of microservices,
wherein the order manager is configured to repeat:
passing, to the sequential microservice, data corresponding to a minimum timestamp message having a minimum timestamp in a message queue containing a predetermined number of messages consumed from the plurality of microservices;
continuing to consume a new message one by one from the plurality of microservices until a message with a timestamp greater than the minimum timestamp message is obtained, and
adding the message with the greater timestamp to the message queue when the message with the greater timestamp is obtained.

2. The data processing system according to claim 1, further comprising:
a message broker configured to broker metadata of a message between the plurality of microservices and the sequential microservice; and
a database in which a payload corresponding to each message is stored,
wherein the order manager is configured to retrieve from the database the payload corresponding to the metadata consumed from the message broker.

3. A data processing system, comprising:
at least one message producer; and
a plurality of message consumers; and
a message broker configured to broker metadata of a message between the at least one message producer and the plurality of message consumers; and
a database in which a payload corresponding to each message is stored,
wherein each of the plurality of message consumers is configured to retrieve from the database the payload corresponding to the metadata consumed from the message broker.

4. A method for managing an order in which a sequential manager processes data processed in parallel by a plurality of microservices, the method comprising repeating steps of:
passing, to the sequential microservice, data corresponding to a minimum timestamp message having a minimum timestamp in a message queue containing a predetermined number of messages consumed from the plurality of microservices;
continuing to consume a new message one by one from the plurality of microservices until a message with a timestamp greater than the minimum timestamp message is obtained, and
adding the message with the greater timestamp to the message queue when the message with the greater timestamp is obtained.

5. A non-transitory computer-readable storage medium storing a program including a plurality of instructions that is executed by at least one processor and causes the at least one processor to function as the sequential microservice, the plurality of microservices, and the order manager included in the data processing system according to claim 1.
